(19) United States
(12) Patent Application Publication
(10) Pub. No.: US 2025/0346015 A1
(43) Pub. Date: Nov. 13, 2025

(54) CURVED WALL COMPRISING AN ALTERNATION OF METAL AND COMPOSITE LAYERS, AND METHOD TO PRODUCE IT

(71) Applicant: COEXPAIR DYNAMICS, Namur (BE)

(72) Inventor: André BERTIN, Vedrin (BE)

(21) Appl. No.: 18/870,911

(22) PCT Filed: Jun. 1, 2023
(86) PCT No.: PCT/EP2023/064732

§ 371 Date: Dec. 2, 2024

(30) Foreign Application Priority Data
Jun. 2, 2022 (EP) 22177045.6

(51) Int. Cl. B32B 1/00; B32B 5/12; B32B 7/12; B32B 15/14; B32B 38/00

(52) U.S. Cl. CPC B32B 1/00; B32B 5/12; B32B 7/12; B32B 15/14; B32B 38/0036; B32B 2250/03; B32B 2250/04; B32B 2260/023; B32B 2260/046; B32B 2262/106; B32B 2307/7376; B32B 2311/18; B32B 2605/18

(57) ABSTRACT

The present disclosure relates to a curved wall comprising an alternation of metal and composite layers, and to a method to produce it. The metal layer is made of aligned metal strips and can thus conform to any shape of the curved wall.

### CROSS-REFERENCE TO RELATED APPLICATION(S)

This present application is a national stage application of International Patent Application No. PCT/EP2023/064732, filed Jun. 1, 2023, which claims priority to European Patent Application No. 22177045.6, filed Jun. 2, 2022, the disclosures of which are hereby incorporated by reference in their entireties.

### TECHNICAL FIELD

The present disclosure relates to a curved wall comprising composite material, and to items comprising such a curved wall. The disclosure also relates to a method to produced such a curved wall.

### BACKGROUND

It is known to use composite materials for curved walls in various applications. However, known walls of composite materials may not be hermetic, especially for liquids or gases.

### SUMMARY

An object of the disclosure is to provide a curved wall having an especially high tightness. According to this first aspect, the disclosure provides a curved wall comprising, in this order:
a first composite layer,
a first metal layer, and
a second composite layer;
wherein the first and the second composite layers comprise carbon fibers;
wherein the first metal layer comprises metal strips of titanium-based material;
wherein the metal strips have a thickness between 1 and 500 μm and a width between 2 and 200 mm;
wherein the metal strips of the first metal layer cover at least 80% of the surface of the first metal layer.

The presence of a metal layer between the composite layers creates a barrier for molecules, which increases the tightness of the wall. The use of strips for the metal layer, narrower than 200 mm, helps for following the curved shape: a foil of higher width may create folds when following the curve. The low thickness of the metal strips provides an especially light wall, which is interesting for aero-spatial applications. Because of its ductility, the titanium-based material makes the rupture of the stress introduction point more progressive in case of an overload on the curved-wall. The combination of the carbon fibers and the titanium-based material is especially interesting because there is no galvanic corrosion between these materials, and their coefficients of thermal expansion are close. This is especially interesting for cryogenic applications where micro cracks may appear, impeding tightness.

In the frame of the present document, a “titanium-based material” is made of titanium and/or an alloy comprising at least 50% of titanium in atomic percent, preferably at least 60%. Examples are Ti-6Al-4V, Ti-15V-3Cr-3Al-3Sn or Ti-6Al-7Nb.

The external surface of the wall may be a metal layer or a composite layer. The internal surface of the wall may be a metal layer or a composite layer.

The thickness of the first and the second composite layers is preferably between 50 and 200 μm.

Preferably, the metal strips of any of the layer have the same width. The width of the metal strips may change, or not, between metal layers.

The curved wall preferably comprises a third metal layer and a third composite layer located between the second and the third metal layers.

The first metal layer is preferably in contact with the first composite layer and the second composite layer. The second metal layer is preferably in contact with the second composite layer, and possibly also with a third composite layer.

If the radius of curvature of the internal surface of the curved wall is below 1 meter, the width of the metal strips is preferably below 100 mm.

In an embodiment of the disclosure, the curved wall has at least one region where it is non-developable. In a non-developable region, a metal foil cannot follow the shape of the wall. Metal strips are therefore especially interesting. A non-developable region of the wall is a region where the Gauss curvature is different than zero.

In an embodiment of the disclosure, the curved wall comprises a second metal layer such that the second composite layer is between the first metal layer et and the second metal layer, the second metal layer comprising metal strips of titanium-based material having a thickness between 1 and 500 μm and a width between 2 and 200 mm, and covering at least 80% of the surface of the second metal layer.

In an embodiment of the disclosure, at least some of the metal strips of the first metal layer are parallel to a first direction and at least some of the metal strips of the second metal layer are parallel to a second direction different from the first direction. Having metal strips in different directions improves the mechanical properties and the tightness of the wall. At least some of the metal strips of the third metal layer are preferably in a direction than is different from the first direction and from the second direction. The directions of the metal strips is preferably such that there is an angle between 10° and 170° between two successive metal layers.

In an embodiment of the disclosure, the carbon fibers of the second composite layer are included in carbon-based strips. The width of the carbon-based strips is preferably between 2 and 500 mm, more preferably between 2 and 100 mm.

In the frame of the present document, a “carbon-based strip” is a strip comprising carbon fibers. It may also comprise a resin, preferably an epoxy.

In an embodiment of the disclosure, at least some of the carbon-based strips of the second composite layer are parallel to a third direction.

The third direction is different from the first direction and from the second direction. Therefore, the strips are in different directions in three layers, which improves the mechanical properties of the curved wall. The directions of the carbon-based strips is preferably such that there is an angle between 10° and 170° between two successive composite layers.

The directions of the metal strips and the carbon-based strips is preferably such that there is an angle between 10° and 170° between two adjacent layers, one of the adjacent layers being a metal layer and the other being a composite layer.

It is possible that the second composite layer comprise several composite sub-layers with carbon-based strips in different directions.

In an embodiment of the disclosure, the carbon-based strips have a width that is at most ten times the width of the metal strips of the first metal layer, and/or the width of the metal strips of the first metal layer is at most ten times the width of the carbon-based strips. This makes easier the production of the wall.

In an embodiment of the disclosure, the distance between two successive metal strips of the first metal layer is lower than 5 mm, preferably lower than 1 mm. Two successive metal strips may partially overlay. They are preferably placed next to each other with a distance as small as possible. However, the disclosure works even with a distance that is not extremely small, of the order of a few millimeters. It may also happen that the distance between two successive metal strips change because of the curvature of the wall.

In an embodiment of the disclosure, the curved wall comprises, at an interface between one of the composite layers and the first metal layer, a bonding agent comprising a complex of an organometallic and an organosilane. The bonding agent may be any material improving the adhesion between the composite layer and the metal layer. It may be in a layer between the composite layer and the metal layer, and/or included in the composite layer.

An object of the disclosure is a fuel tank for liquid and/or gaseous fuel comprising such a curved wall. The fuel tank is preferably a cryogenic fuel tank suitable for containing fuel at temperatures below 150° C. The fuel may be gaseous and/or liquid hydrogen. The fuel tank has preferably a non-developable curved wall, for example a spherical wall. The curved wall according to the disclosure may be included at least in the non-developable parts of the fuel tank wall. The metal layer, or the plurality of metal layers, is preferably closer to the internal surface of the wall than the external surface of the wall.

An object of the disclosure is an aircraft nose comprising such a curved wall. The curved wall according to the disclosure provides an especially high resistance to erosion. Moreover, the metal layers may be used as heating resistances to heat the aircraft nose. Many other applications of the curved wall are possible.

An object of the disclosure is a method for producing a curved wall comprising the successive steps of:
forming a first composite layer,
forming a first metal layer, and
forming a second composite layer;
wherein the first and the second composite layers comprise carbon fibers;
wherein the step of forming the first metal layers is realized with an automated tool and comprises applying metal strips of titanium-based material on the first composite layer, in such a way that a mechanical tension is created between the part of the metal strips already placed on the first composite layer and the part of the metal strips to be placed on the first composite layer,
wherein the metal strips have a thickness between 1 and 500 μm and a width between 2 and 200 mm; and
wherein the metal strips of the first metal layer cover at least 80% of the surface of the first metal layer, and the metal strips of the second metal layer are parallel and cover at least 80% of the surface of the second metal layer.

The shift between two successive parallel metal strips is automated.

Filament winding and/or automated fiber placement may be used to produce a curved wall according to the disclosure.

The tension is preferably applied by a tension application device.

The carbon-based strips may also be applied on the underlying metal layer by the automated tool.

The shape of the curved wall is programmed in the automated tool in such a way that the positioning of the metal strips is automated.

The step of forming the second metal layers preferably comprises applying metal strips of titanium-based material on the second composite layer, in such a way that a mechanical tension is created between the part of the metal strips already placed on the second composite layer and the part of the metal strips to be placed on the second composite layer. The second metal layer is preferably formed with an automated tool, which is preferably the same as the one used for the first metal layer.

In an embodiment of the disclosure, after being placed on the first composite layer, the metal strips of the first metal layer are pressed against the first composite layer. It improves the positioning and the adhesion. The pressure is preferably applied by a compression device, for example a roller. The compression device moves. Its motion is automated.

In an embodiment of the disclosure, the automated tool comprises a mobile part, which comprises an application guide positioning the part of the metal strips to be applied with respect to the first composite layer or the second composite layer. The mobile application guide improves the positioning. Its motion is automated.

In an embodiment of the disclosure, wherein the part of the metal strips to be applied is heated or cooled before being placed on the first composite layer or the second composite layer. The temperature is preferably increased or decreased by a heating and/or cooling device.

### BRIEF DESCRIPTION OF THE DRAWINGS

For a better understanding of the present disclosure, reference will now be made, by way of example, to the accompanying drawings in which: FIG. 1 is a cross-section of a curved wall,

FIG. 2 illustrates a possible arrangement of metal strips,

FIG. 3 illustrates a possible relative location of successive composite and metal layers,

FIG. 4 is a cross-section of a fuel tank,

FIG. 5 is a cross-section of an aircraft nose, and

FIG. 6 illustrates a placement of a metallic strip with an automated tool.

### DETAILED DESCRIPTION

The present disclosure will be described with respect to particular embodiments and with reference to certain drawings but the disclosure is not limited thereto. The described functions are not limited by the described structures. The drawings described are only schematic and are non-limiting. In the drawings, the size of some of the elements may be exaggerated and not drawn on scale for illustrative purposes.

Furthermore, the terms first, second, third and the like in the description and in the claims, are used for distinguishing between similar elements and not necessarily for describing a sequential or chronological order. The terms are interchangeable under appropriate circumstances and the embodiments of the disclosure can operate in other sequences than described or illustrated herein.

Furthermore, the various embodiments, although referred to as “preferred” are to be construed as exemplary manners in which the disclosure may be implemented rather than as limiting the scope of the disclosure.

The term “comprising”, used in the claims, should not be interpreted as being restricted to the elements or steps listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising A and B” should not be limited to devices consisting only of components A and B, rather with respect to the present disclosure, the only enumerated components of the device are A and B, and further the claim should be interpreted as including equivalents of those components.

On the FIGS., identical or analogous elements may be referred by a same number.

FIG. 1 illustrates a curved wall 1 in an embodiment of the disclosure. The curved wall 1 comprises a first composite layer 11, a first metal layer 21, a second composite layer 12, and, preferably, a second metal layer 22. It may also comprise a third composite layer 13, a third metal layer 23, and a fourth composite layer 14. The curved wall 1 preferably comprise an alternation of metal and composite layers on a thickness higher than 1 mm and lower than 10 cm, more preferably lower than 2 cm. It may for example include at least ten composite layers interposed between at least eleven metal layers.

The composite layers 11, 12 comprise carbon fibers and, preferably a resin. The composite layers 11, 12 may comprise carbon-based strips 40. The composite layers 11, 12 preferably have a thickness 41 below 200 μm. The composite layers 11, 12 are preferably thicker than the metal layers 21, 22.

Since the composite layers 11, 12 are made of an elastic material, the metal layers 21, 22 may be integrated within one or two of the adjacent composite layers 11, 12.

The metal layers 21, 22 comprise metal strips 30 of titanium-based material. The metal strips 30 have a thickness 31 between 1 and 500 μm, preferably between 1 and 100 μm. Within a metal layer 21, 22, they are preferably parallel to each other. They may be separated by a lateral distance 33 below 5 mm, preferably below 1 mm, in such a way that at least 80% of the surface of any the metal layers 21, 22 is made of metal strips 30. The metal strips 30 may partially overlay. In such a case, there is preferably an adhesive on the interface between the two metal strips 30.

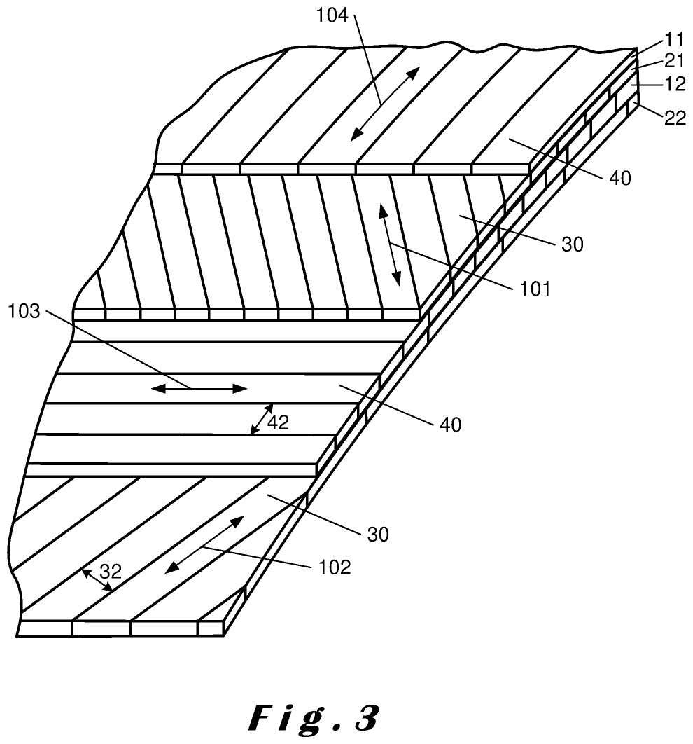

Within a metal layer 21, 22, the metal strips 30 preferably have identical width 32 (FIG. 3) and/or identical thickness 31. Preferably, the width 32 (FIG. 3) of the metal strips 30 of the first metal layer 21 and the second metal layer 22 is identical.

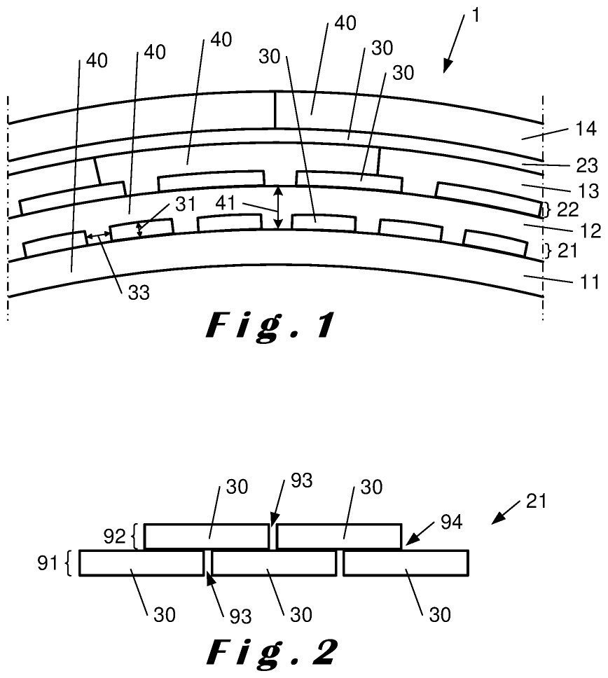

The apparent difference in width between the metal strips 30 (or the carbon-based strips) in FIG. 2 comes from the difference in direction of the strips between the layers, as illustrated on FIG. 3, which may create cross-sections of different sizes even for strips of the same width.

A bonding agent may be present between, one the one side, the metal of the metal layers 21, 22 and, on the other side, the resin and/or the carbon of the composite layers 11, 12. It is applied on the metal and/or the composite before there are joined. In an embodiment of the disclosure, an organometallic and an organosilane are mixed to create a complex that forms the bonding agent. The bonding agent may be a sol-gel.

FIG. 2 illustrates the first metal layer 21 in an arrangement wherein it comprises two sub-layers 91, 92. The metal strips 30 of the sub-layers 91, 92 may be aligned in different directions. There is preferably an adhesive where the two metal strips 30 are in contact with each other, for example at the interface 94 between the sub-layers 91, 92. The space lateral space 93 between two metal strips 30 of any of the sub-layers 91, 92 is preferably filled with resin and/or with the adhesive.

FIG. 3 shows a superposition of composite layers 11, 12 and metal layers 21, 22. The metal strips 30 of the first composite layer 21 are parallel to a first direction 101. The metal strips 30 of the second layer 22 are parallel to a second direction 102, which is tilted with respect to the first direction 101, preferably by an angle of at least 10°. The first direction 101 and the second direction 102 make preferably an angle between 10° and 170°. The carbon-based strips 40 of the second composite layer 12 are parallel to a third direction 103, which is tilted with respect to the first direction 101 and to the second direction 102, preferably by angles of at least 10°. The carbon-based strips 40 of the first composite layer 11 are parallel to a fourth direction 104, which is tilted with respect to the first direction 101 and to the third direction 103, preferably by angles of at least 10°.

Preferably, the width 32 of the metal strips 30 is not more than ten times larger than the width 42 of the carbon-based strips 40, and/or the width 42 of the carbon-based strips 40 is not more than ten times larger than the width 32 of the metal strips 30. This preferably applies even if the metal strips 30 of different metal layers 21, 22 have different widths, and/or the carbon-based strips 40 of different composite layers 11, 12 have different widths.

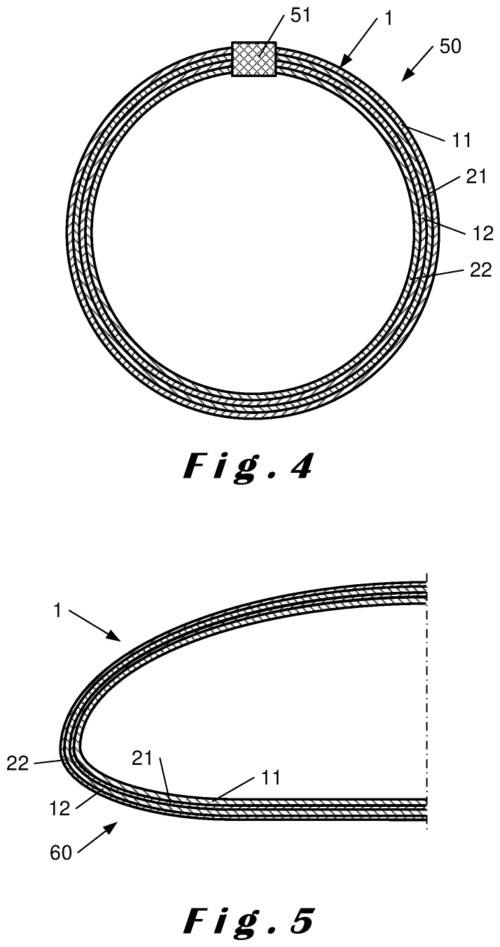

FIGS. 4 and 5 illustrates two examples of curved walls 1 having at least one region where the wall is not developable.

FIG. 4 shows a fuel tank 50. It comprises an opening 51. The internal surface of the fuel tank 50 may be a metal layer of the curved wall 1, as illustrated, or a composite layer of the curved wall 1. It may also be another layer coated on a curved wall 1, even if this embodiment is less preferred.

FIG. 5 shows a nose 60 of an aircraft. The external surface is preferably a metal layer.

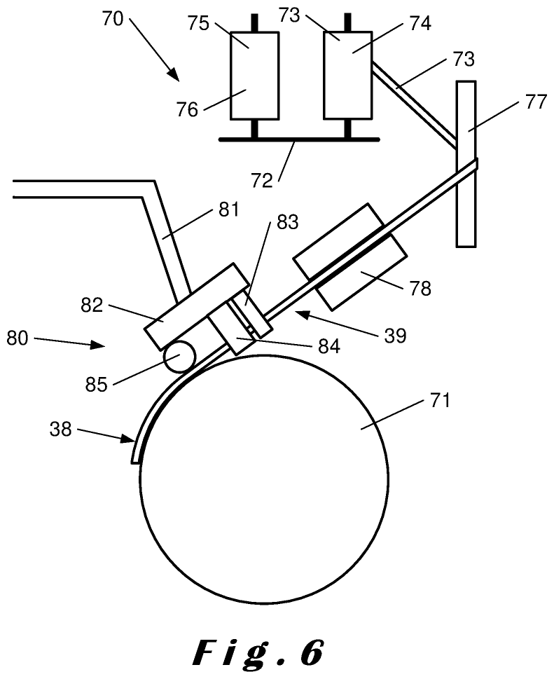

FIG. 6 schematized an automated tool 70 placing the first metal layer 21 on the first composite layer 11 (not shown) already shaped as a curved wall under construction 71.

The automated tool 70 preferably comprises a support 72 for a spool 76 of a carbon-based ribbon 75 that will be cut in carbon-based strips 40. The support 72 also supports a spool 74 of metal ribbon 73 that will be cut in metal strips 30. The ribbons 73, 75 may be cut before being applied on the curved wall under construction 71 or after at least one part of them has been applied on the curved wall under construction 71. The automated tool 70 preferably comprises a guiding system 77 guiding the ribbon 73 being placed between the spool 74 and an application guide 84. The ribbon 73 may be heated or cooled by a heating and/or cooling device 78.

The resin is preferably present in the carbon-based ribbon 75, and some additional resin may be added later in the production process.

The bonding agent may be present on at least one of the ribbons 73, 75 on the spool 74, 76 or may be placed on at least one of the ribbons 73, 75 by the automated tool 70.

The automated tool 70 may comprise a mobile part 80, for example comprising an arm 81 and a mobile head 82. The automated tool 70 comprises a tension application device 83 that applies a tension, preferably by pulling, on the part 39 of the metal strips 30 to be placed on the first composite layer 11, to keep it taut with respect to the part 38 of the metal strips 30 already placed on the first composite layer 11 and adhering to the curved wall under construction 71. The automated tool 70 may comprise a compression device 85 pressing on the part 38 of the metal strips 30 placed on the first composite layer 11.

After application of all the layers 11, 12, 21, 22, etc., the curved wall 1 is preferably heated to cure the resin.

In other words, the disclosure relates to a curved wall 1 comprising an alternation of metal layer 21 and composite layers 11, 12, and to a method to produce it. The metal 21 layer is made of aligned metal strips 30 and can thus conform to any shape of the curved wall 1.

Although the present disclosure has been described above with respect to particular embodiments, it will readily be appreciated that other embodiments are also possible.

1. A curved wall comprising, in this order:
a first composite layer,
a first metal layer, and
a second composite layer;
wherein the first and the second composite layers comprise carbon fibers;
wherein the first metal layer comprises metal strips of titanium-based material;
wherein the metal strips have a thickness between 1 and 500 μm and a width between 2 and 200 mm; and
wherein the metal strips of the first metal layer cover at least 80% of a surface of the first metal layer.

2. The curved wall according to claim 1, wherein the curved wall has at least one region where it is non-developable.

3. The curved wall according to claim 1, comprising a second metal layer such that the second composite layer is between the first metal layer et and the second metal layer, the second metal layer comprising metal strips of titanium-based material having a thickness between 1 and 500 μm and a width between 2 and 200 mm, and covering at least 80% of the surface of the second metal layer.

4. The curved wall according to claim 3, wherein at least some of the metal strips of the first metal layer are parallel to a first direction and at least some of the metal strips of the second metal layer are parallel to a second direction different from the first direction.

5. The curved wall according to claim 1, wherein the carbon fibers of the second composite layer are included in carbon-based strips.

6. The curved wall according to claim 5, wherein at least some of the carbon-based strips of the second composite layer are parallel to a third direction.

7. The curved wall according to claim 5, wherein the carbon-based strips have a width that is at most ten times the width of the metal strips of the first metal layer, and/or the width of the metal strips of the first metal layer is at most ten times the width of the carbon-based strips.

8. The curved wall according to claim 1, wherein a distance between two successive metal strips of the first metal layer is lower than 5 mm, preferably lower than 1 mm.

9. The curved wall according to claim 1, comprising, at an interface between one of the first and the second composite layers and the first metal layer a bonding agent comprising a complex of an organometallic and an organosilane.

10. A fuel tank for liquid and/or gaseous fuel comprising a curved wall according to claim 1.

11. An aircraft nose comprising a curved wall comprising, in this order:
a first composite layer,
a first metal layer, and
a second composite layer;
wherein the first and the second composite layers comprise carbon fibers;
wherein the first metal layer comprises metal strips of titanium-based material;
wherein the metal strips have a thickness between 1 and 500 μm and a width between 2 and 200 mm; and
wherein the metal strips of the first metal layer cover at least 80% of a surface of the first metal layer.

12. A method for producing a curved wall comprising the successive steps of:
forming a first composite layer,
forming a first metal layer, and
forming a second composite layer;
wherein the first and second composite layers comprise carbon fibers;
wherein the step of forming the first metal layers is realized with an automated tool and comprises applying metal strips of titanium-based material on the first composite layer, in such a way that a mechanical tension is created between a part of the metal strips already placed on the first composite layer and the part of the metal strips to be placed on the first composite layer,
wherein the metal strips have a thickness between 1 and 500 μm and a width between 2 and 200 mm; and
wherein the metal strips of the first metal layer cover at least 80% of a surface of the first metal layer, and the metal strips of the second metal layer are parallel and cover at least 80% of the surface of the second metal layer.

13. The method according to claim 12, wherein, after being placed on the first composite layer, the metal strips of the first metal layer are pressed against the first composite layer.

14. The method according to claim 12, wherein the automated tool comprises a mobile part, which comprises an application guide positioning the part of the metal strips to be applied with respect to the first composite layer or the second composite layer.

15. The method according to claim 14, wherein the part of the metal strips to be applied is heated or cooled before being placed on the first composite layer or the second composite layer.

16. The method according to claim 12, wherein the part of the metal strips to be applied is heated or cooled before being placed on the first composite layer or the second composite layer.

17. The method according to claim 13, wherein the part of the metal strips to be applied is heated or cooled before being placed on the first composite layer or the second composite layer.

18. The method according to claim 13, wherein the automated tool comprises a mobile part, which comprises an application guide positioning the part of the metal strips to be applied with respect to the first composite layer or the second composite layer.

19. The curved wall according to claim 6, wherein the carbon-based strips have a width that is at most ten times the width of the metal strips of the first metal layer, and/or the width of the metal strips of the first metal layer is at most ten times the width of the carbon-based strips.
